(19) United States
(12) Patent Application Publication
(10) Pub. No.: US 2011/0308986 A1
(43) Pub. Date: Dec. 22, 2011

(54) PACKAGING BOX WITH A RADIO FREQUENCY IDENTIFICATION TAG

(75) Inventor: Bong Su Lee, Yangpyeong-gun (KR)

(73) Assignee: SAM HWA DANG P AND T CO., LTD, Seoul (KR)

(21) Appl. No.: 13/203,640

(22) PCT Filed: Mar. 2, 2010
(86) PCT No.: PCT/KR10/01283

§ 371 Date: Aug. 26, 2011

(30) Foreign Application Priority Data
Feb. 27, 2009 (KR) 10-2009-0017241
Sep. 25, 2009 (KR) 10-2009-0090966

(51) Int. Cl. B65D 5/44; G06K 19/077; B65D 5/4805

(52) U.S. Cl. 206/459.1; 229/120.08; 229/120.15

(57) ABSTRACT

The present invention relates to a packaging box with a radio frequency identification (RFID) tag. The packaging box is made by folding one sheet, and has a main compartment space and an auxiliary compartment space separated from each other. The main compartment space accommodates articles, and the auxiliary compartment space is provided with the RFID tag. The surface of at least a portion of the auxiliary compartment space forms a portion of the surface of the packaging box. Accordingly, electromagnetic and physical interferences with the RFID tag placed inside the packaging box can be prevented even in the event the articles in the packaging box contain a silver foil or an aluminum material, or have sharp edges, thereby ensuring the stable operation of the RFID tag.

### TECHNICAL FIELD

The present invention relates to a packaging box with a radio frequency identification (RFID) tag placed inside, and more particularly, to a packaging box with a radio frequency identification (RFID) tag that can ensure a stable operation of the RFID tag by preventing electromagnetic and physical interference with the RFID tag placed inside the packaging box even when contents in the packaging box contain silver foil or an aluminum material, or have sharp edges.

### BACKGROUND ART

In general, drugs such as tablets (pills) or capsules are primarily packaged in a pocket type packaging structure so as to prevent penetration of moisture or oxygen and damage and to individually separate the drugs, and then the drugs are finally placed in a packaging box.

Recently, as there have been suggested technologies to allow inventory management, security, copy prevention and distribution channel tracking through electronic tag technologies using contactless radio signals such as a radio frequency identification (RFID) tag, an electronic product code (EPC) tag, and an electronic article surveillance (EAS) tag, these technologies are being applied, for example, by attaching the electronic tag inside a packaging box to prevent a consumer's direct access.

However, in the pocket type packaging structure for primarily packaging the pills or the capsules, a resin support is covered with metal foil such as silver foil or aluminum foil and the metal foil causes interference such as reflecting electromagnetic waves applied to the electronic tag placed in the packaging box, thereby deteriorating receiving efficiency. Consequently, the electromagnetic interference can be relatively reduced by generally installing the electronic tag at a side corresponding to an edge of the packaging structure, but it is still difficult to completely remove the influence of the metal foil used for the primary packaging of the contents.

In addition, since the pocket type packaging structure in general has the shape of a thin plate, the edge is relatively hard and sharp. For this reason, a physical defect of an electric structure of the electronic tag generally constructed by printing conductive ink may occur, for example, when the edge is in contact with an antenna or other components of the electronic tag attached inside the packaging box at the time of filling or transporting the contents.

Accordingly, in respect of the packaging box with the electronic tag, there is still an intense demand for a packaging box that can prevent the electromagnetic interference with the electronic tag and physical damage of the electronic tag, facilitate installation of the electronic tag, and be manufactured at low cost through a simple process.

### DISCLOSURE

### Technical Problem

The present invention is contrived to improve a structure of the packaging box with the electronic tag in the related art and provide a variety of added advantages. An object of the present invention is to provide a new packaging box that can ensure a stable operation of a radio frequency identification (RFID) tag by preventing electromagnetic interference with the RFID tag placed inside the packaging box, for example, even when contents in the packaging box contain silver foil or an aluminum material.

Another object of the present invention is to provide a new packaging box that can ensure an attachment position of the RFID tag and independency between the contents and the RFID tag by providing a separate shelter space or exclusive space only for the RFID tag inside the packaging box to prevent unnecessary physical access to the RFID tag.

Yet another object of the present invention is to provide a new packaging box that can keep the inside of the packaging box clean and continue to maintain an operation of the RFID tag even after opening the packaging box by preventing consumer access to the RFID tag even when the packaging box is opened.

Still another object of the present invention is to provide a new packaging box that can remarkably reduce costs through a simple manufacturing process of the packaging box and easy installation of the RFID tag by forming both a space for accommodating the contents and a space for accommodating the RFID tag in a process of folding one sheet.

### Technical Solution

The objects can be achieved by providing a packaging box with a radio frequency identification (RFID) tag according to the present invention.

According to an aspect of the present invention, the packaging box with the RFID tag includes a main space part accommodating contents and an auxiliary space part separated from the main space part through a partition, in which the auxiliary space part is provided with the RFID tag and the surface of at least a portion of the auxiliary space part may form a portion of the surface of the packaging box.

According to an exemplary embodiment of the present invention, the packaging box has the shape of a polyhedron which is formed by folding one sheet.

According to another exemplary embodiment of the present invention, on the one sheet, a base sheet part forming an exterior shape of the packaging box and an auxiliary sheet part forming the auxiliary space part are continuously formed.

According to another exemplary embodiment of the present invention, the surface of at least a portion of the auxiliary space part that is a portion of the surface of the packaging box has a planar shape.

According to another exemplary embodiment of the present invention, the RFID tag is constructed by printing an antenna pattern on one side surface of the auxiliary space part with conductive ink and separately attaching a strap to the center of the antenna pattern so that the antenna pattern and the strap are electrically connected to each other.

According to another exemplary embodiment of the present invention, the base sheet part is folded to form the shape of a hexahedron, the base sheet part including: a front surface part forming a front surface of the hexahedron; a top surface part foldably and continuously formed at an upper end of the front surface part to form a top surface of the hexahedron and having an upper wing; a first side surface part foldably and continuously formed at one end of the front surface part to form one side surface of the hexahedron; a rear surface part foldably and continuously formed at one end of the first side surface part to form a rear surface of the hexahedron; a second side surface part foldably and continuously formed at the other end of the front surface part to form the other side surface of the hexahedron; a flap part foldably and continuously formed at one end of the second side surface part and folded to be stackable on the rear surface part; and a bottom surface part foldably and continuously formed at a lower end of the rear surface part to form a bottom surface of the hexahedron and having a lower wing.

In this case, the auxiliary sheet part may include: a first auxiliary surface foldably and continuously formed from one end of the rear surface part of the base sheet part and facing the first side surface part; a second auxiliary surface foldably and continuously formed from one end of the first auxiliary surface, having a length shorter than that of the front surface part by a predetermined length, and facing the rear surface part; a third auxiliary surface foldably and continuously formed at one end of the second auxiliary surface and facing the first auxiliary surface; and an adhesion part foldably and continuously formed from one side of the third auxiliary surface and adhered to an inner surface of the rear surface part, such that a space between the third auxiliary surface and the second side surface part may form an auxiliary space part.

According to another exemplary embodiment of the present invention, the base sheet part is folded to form the shape of a hexahedron, the base sheet part including: a front surface part forming a front surface of the hexahedron; a top surface part foldably and continuously formed at an upper end of the front surface part to form a top surface of the hexahedron and having an upper wing; a first bottom surface part foldably and continuously formed at a lower end of the front surface part to form a portion of a bottom surface of the hexahedron; a first side surface part foldably and continuously formed at one end of the front surface part to form one side surface of the hexahedron and having upper and lower wings foldably and continuously formed at upper and lower ends; a second side surface part foldably and continuously formed at the other end of the front surface part to form the other side surface of the hexahedron and having upper and lower wings foldably and continuously formed at upper and lower ends; a rear surface part foldably and continuously formed at one end of the second side surface part and corresponding to the front surface part; a second bottom surface part foldably and continuously formed at a lower end of the rear surface part to form another portion of the bottom surface of the hexahedron; a first flap part foldably and continuously formed at an upper end of the rear surface part and folded to be stackable on the surface of the top surface part; and a second flap part foldably and continuously formed at an upper end of the first flap part and overlapping with the first flap part.

In this case, the auxiliary sheet part may include a first auxiliary surface foldably and continuously formed at an upper end of the upper wing of the top surface part and facing the top surface part; a second auxiliary surface foldably and continuously formed from the first auxiliary surface and facing the upper wing; and an adhesion part foldably and continuously formed from the second auxiliary surface and adhered to an inner surface of the top surface part, such that an auxiliary space part may be formed inside the upper wing of the top surface part, the first and second auxiliary surfaces, and the adhesion part.

According to another exemplary embodiment of the present invention, the base sheet part is folded to form the shape of a hexahedron, the base sheet part including: a front surface part forming a front surface of the hexahedron; a top surface part foldably and continuously formed at an upper end of the front surface part to form a top surface of the hexahedron and having an upper wing; a bottom surface part foldably and continuously formed at a lower end of the front surface part to form a bottom surface of the hexahedron; a first side surface part foldably and continuously formed at one end of the front surface part to form one side surface of the hexahedron and having upper and lower wings at upper and lower ends; a second side surface part foldably and continuously formed at the other end of the front surface part to form the other side surface of the hexahedron and having upper and lower wings at upper and lower ends; a rear surface part foldably and continuously formed at one end of the second side surface part to form a rear surface of the hexahedron and having wings at a lower end and one end, respectively; and a flap part foldably and continuously formed at an upper end of the rear surface part and folded to be stackable on the surface of the top surface part.

In this case, the auxiliary sheet part may include: a first auxiliary surface foldably and continuously formed at a lateral end of a lateral wing formed on one side surface of the rear surface part and facing the rear surface part; a second auxiliary surface foldably and continuously formed from the first auxiliary surface and facing the wing; and an adhesion part foldably and continuously formed from the second auxiliary surface and adhered to an inner surface of the rear surface part, such that an auxiliary space part may be formed inside the lateral wing, the first and second auxiliary surfaces, and the adhesion part.

According to another exemplary embodiment of the present invention, the base sheet part is folded to form the shape of a hexahedron, the base sheet part including: a front surface part forming a front surface of the hexahedron; a top surface part foldably and continuously formed at an upper end of the front surface part to form a top surface of the hexahedron and having an upper wing; a bottom surface part foldably and continuously formed at a lower end of the front surface part to form a bottom surface of the hexahedron; a first side surface part foldably and continuously formed at one end of the front surface part to form one side surface of the hexahedron and having upper and lower wings at upper and lower ends; a second side surface part foldably and continuously formed at the other end of the front surface part to form the other side surface of the hexahedron and having upper and lower wings at upper and lower ends; and a rear surface part foldably and continuously formed at one end of the second side surface part to form a rear surface of the hexahedron and having wings at a lower end and one end, respectively.

In this case, the auxiliary sheet part may include a first auxiliary surface foldably and continuously formed at a lateral end of a lateral wing formed on one side surface of the rear surface part and facing the rear surface part; a second auxiliary surface foldably and continuously formed from the first auxiliary surface and facing the wing; and an adhesion part foldably and continuously formed from the second auxiliary surface and adhered to an inner surface of the rear surface part, such that an auxiliary space part may be formed inside the lateral wing, the first and second auxiliary surfaces, and the adhesion part.

### Advantageous Effects

According to the present invention, the packaging box can ensure a stable operation of the RFID tag by preventing electromagnetic interference with the RFID tag placed inside the packaging box and/or physical damage of the RFID tag, for example, even when contents in the packaging box contain silver foil or an aluminum material.

According to the present invention, the packaging box can ensure an attachment position of the RFID tag and independency between the contents and the RFID tag by providing a separate shelter space or exclusive space only for the RFID tag inside the packaging box to prevent unnecessary physical access to the RFID tag.

Further, according to the present invention, the packaging box can keep the inside of the packaging box clean and continue to maintain an operation of the RFID tag even after opening the packaging box by preventing consumer access to the RFID tag even when the packaging box is opened.

In addition, according to the present invention, the packaging box can remarkably reduce costs through a simple manufacturing process of the packaging box and easy installation of the RFID tag by forming both a space for accommodating the contents and a space for accommodating the RFID tag in a process of folding one sheet.

### DESCRIPTION OF DRAWINGS

FIG. 1 is a development diagram of a packaging box according to a first exemplary embodiment of the present invention.

FIG. 2 is a diagram showing a state where an auxiliary sheet part of the packaging box according to the first exemplary embodiment of the present invention is folded.

FIG. 3 is a diagram showing a state where a base sheet part of the packaging box according to the first exemplary embodiment of the present invention is folded.

FIG. 4 is a cross-sectional view taken along the line A-A of FIG. 3.

FIG. 5 is a development diagram where a radio frequency identification (RFID) tag is installed on the sheet of the packaging box according to the first exemplary embodiment of the present invention.

FIG. 6 is a development diagram of a packaging box according to a second exemplary embodiment of the present invention.

FIG. 7 is a diagram showing a state where an auxiliary sheet part of the packaging box according to the second exemplary embodiment of the present invention is folded.

FIG. 8 is a diagram showing a state where a base sheet part of the packaging box according to the second exemplary embodiment of the present invention is folded.

FIG. 9 is a development diagram of a packaging box according to a third exemplary embodiment of the present invention.

FIG. 10 is a diagram showing a state where an auxiliary sheet part of the packaging box according to the third exemplary embodiment of the present invention is folded.

FIG. 11 is a diagram showing a state where a base sheet part of the packaging box according to the third exemplary embodiment of the present invention is folded.

FIG. 12 is a development diagram of a packaging box according to a fourth exemplary embodiment of the present invention.

FIG. 13 is a diagram showing a state where an auxiliary sheet part of the packaging box according to the fourth exemplary embodiment of the present invention is folded.

FIG. 14 is a diagram showing a state where a base sheet part of the packaging box according to the fourth exemplary embodiment of the present invention is folded.

### BEST MODE

Hereinafter, the present invention will be described more fully hereinafter with reference to the accompanying drawings, in which exemplary embodiments of the invention are shown.

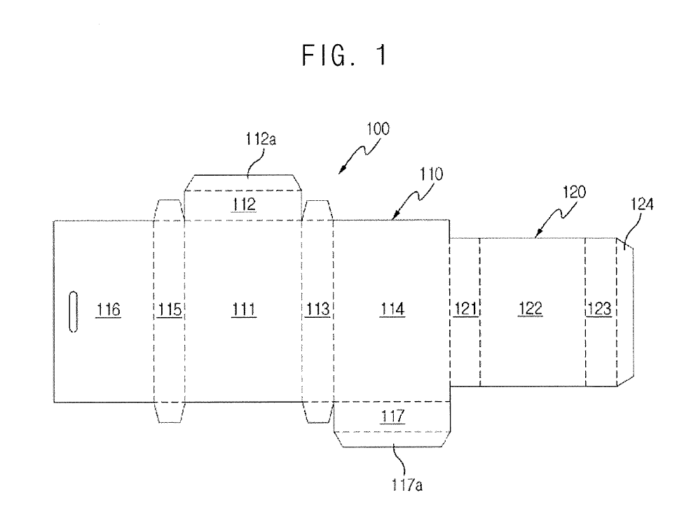

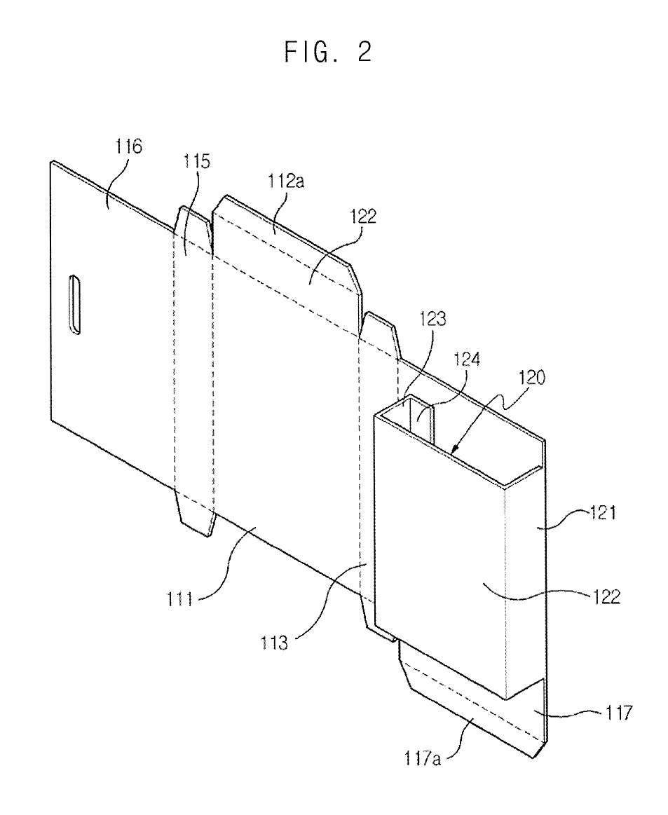

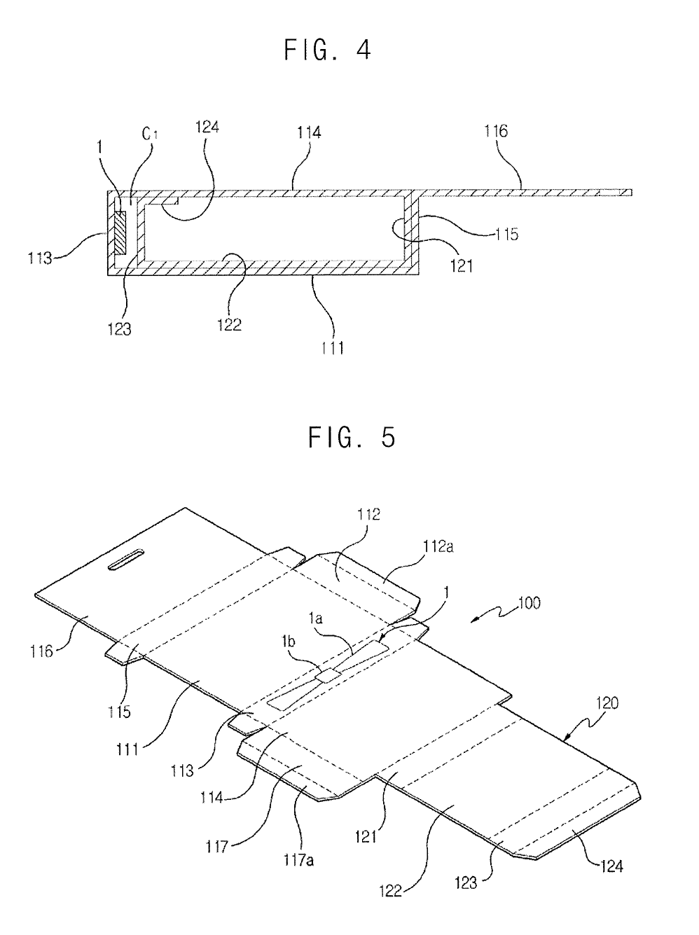

FIGS. 1 to 5 illustrate a packaging box with a radio frequency identification (RFID) tag according to a first exemplary embodiment of the present invention.

A packaging box 100 is a container that includes a main space part accommodating contents primarily packaged by metal foil such as silver foil or aluminum foil like, for example, a pocket type packaging structure 500, and an auxiliary space part C₁ separated from the main space part by a partition. In particular, an RFID tag 1 may be printed or attached by an adhesive to an inner surface of the auxiliary space part C₁.

In the packaging box according to the exemplary embodiment of the present invention, it is sufficient if the RFID tag 1 is installed so that a radio signal can be accessed by a reading device such as a reader (not shown) outside the packaging box, but it is preferable that in order for the external reading device to have access to the RFID tag regardless of a position of the contents even when the contents are surrounded by metal foil that interferes or shields electromagnetic waves, the auxiliary space part is installed around the surface of the packaging box. To this end, it is preferable that the surface of at least a portion of the auxiliary space part forms a portion of the surface of the packaging box.

The exemplary embodiment shown in the drawings is exemplified only by a rectangular parallelepiped box, however, if the box has a separate auxiliary space for installing the RFID tag apart from a space accommodating the contents, any shape box may be used. That is, the shape of, for example, a polyhedron, a polyprism, a cylinder, a cone, or a polypyramid may be used and an irregular shape and a pocket type may be also used.

In the exemplary embodiment, at least a portion of one of the outer surfaces of the packaging box, i.e., one side surface of the auxiliary space part may be a plane type. This is because it is preferable that the RFID tag 1 is installed on a plane surface. The reason is that a reading rate is satisfactory only when an antenna of the RFID tag is installed on the plane surface in a specific frequency band used in general.

In the exemplary embodiment of the present invention, it is preferable that the packaging box has the shape of a polyhedron which is formed by folding one sheet. In this case, it is possible to manufacture the packaging box by only a simple folding process, and therefore a manufacturing process is easy and manufacturing cost is low.

A material of the packaging box, i.e., a material of the sheet is typically paper or paperboard made of pulp or the like, but a material such as rigid or soft plastic, cloth, nonwoven, and wood may be also used. However, it is preferable that the sheet for manufacturing the packaging box according to the present invention does not contain a metal layer that shields electromagnetic waves such as silver foil or aluminum foil.

The RFID tag 1 is installed at a specific region of the sheet when the sheet is developed and thereafter the sheet is folded to complete the packaging box with the RFID tag.

Referring to FIG. 5, when the sheet is developed and thereafter folded, an antenna pattern 1a is printed on one side surface of a portion to be the auxiliary space part, i.e., on an inner wall of a surface forming an outer surface part of the packaging box with conductive ink and a strap 1b is separately attached to the center of the antenna pattern 1a, such that the antenna pattern 1a and the strap 1b are electrically connected to each other. The strap 1b is formed by attaching a chip to a base layer and printing a wire on both sides of the chip with conductive ink and represents a part including all components of the RFID tag other than an antenna.

In the present invention, as shown in the drawings, the sheet may include a base sheet part 110 forming an exterior shape of the packaging box and an auxiliary sheet part 120 forming the auxiliary space part, in which the base sheet part 110 and the auxiliary sheet part 120 are continuously formed.

In the exemplary embodiment as shown in the drawings, the base sheet part 110 is formed in the shape of a rectangular parallelepiped and includes six surfaces forming 6 outer surfaces and an inner space of the folded rectangular parallelepiped. The inner space includes a main space part accommodating the contents and an auxiliary space part separated from the main space part by a partition. The base sheet part 100 corresponds to a portion of the sheet forming a general and basic rectangular parallelepiped box actually without the auxiliary space part C₁.

The base sheet part 110 may include six surface parts basically forming six surfaces of a hexahedron, wing parts(folded or adhered part) added to the respective surface parts, and/or a flap part(a part which is hung on a hook or the like on display), and the like.

In the inner space formed by the base sheet part 110, since the auxiliary space part C₁ exists for the purpose of accommodating the RFID tag, the size of the auxiliary space part C₁ formed by the auxiliary sheet part 120 depends on the size of the RFID.

Generally, as a radio frequency band used by the RFID tag is a high frequency band, a communication length increases, however, since the required size of the antenna should be increased in proportion to the communication length, proper frequency band and antenna length should be selected depending on the size of the packaging box. Therefore, the size of the auxiliary space part may be determined depending on the minimum area required for forming the antenna pattern 1a because the strap 1b in the RFID tag is very small. In general, when the RFID tag is installed, the minimum area for the antenna pattern 1a is approximately 10 mm×3 mm. Meanwhile, the width of the auxiliary space part may be determined depending on the thickness of the RFID tag, but the RFID tag is actually very thin, while the folded sheet may be thicker than the RFID tag. Therefore, the width of the auxiliary space part may be a dimension sufficient to easily fold the sheet rather than the thickness of the RFID tag, for example, the minimum width of approximately 5 to 7 mm.

Hereinafter, according to the first exemplary embodiment as shown in FIGS. 1 to 5, one sheet for a hexahedron-shaped packaging box is provided. The sheet includes a base sheet part 110 and an auxiliary sheet part 120 which are continuously connected to each other.

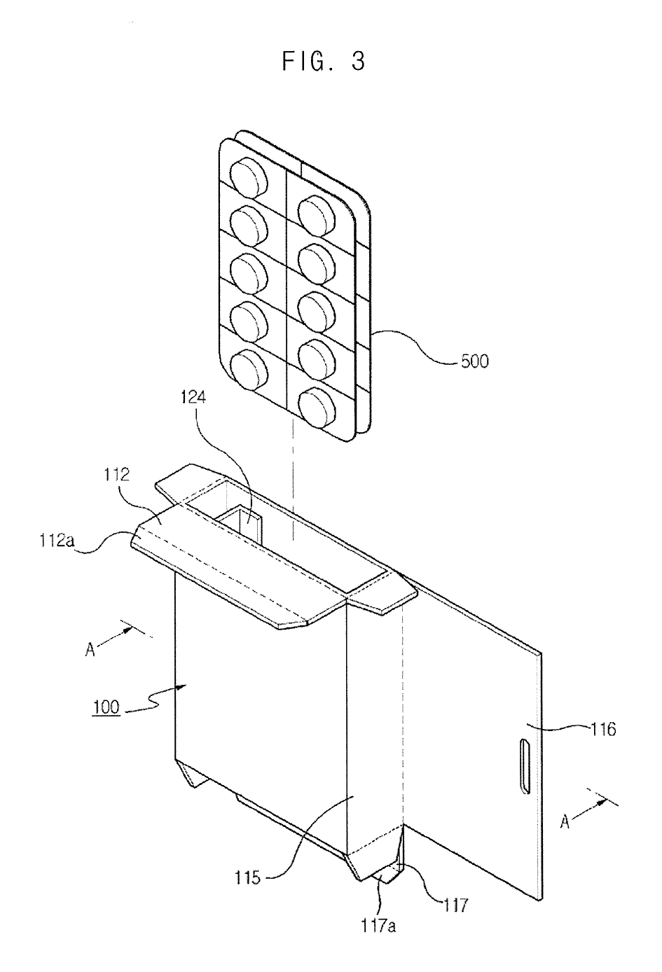

In the exemplary embodiment, after the base sheet part 110 is folded, as shown in FIG. 3, a hexahedral box having narrow top and bottom surfaces and front and rear surfaces with relatively wide widths is formed and a corresponding hexahedral inner space is formed inside. The sheet for the packaging box 100 includes a top surface part 112, a first side surface part 113, a second side surface part 115, and a bottom surface part 117 which form top and bottom side surfaces and are long and narrow, and a front surface part 111 and a rear surface part 114 which are relatively wide.

As shown in FIG. 1, the front surface part 111 of the base sheet part 110 is a surface part defining the widest surface of the packaging box 110. The top surface part 112 is foldably and continuously formed at an upper end of the front surface part 111 to form a top surface (or lid) of the hexahedron and is a long and narrow surface part having an upper wing 112a which is folded inward. The first side surface part 113 is foldably and continuously formed at one end of the front surface part 111 to form one side surface of the hexahedron and includes wing parts adhered to upper and lower portions. Herein, an opposed surface refers to a status in which surfaces that are positioned at the same side when the sheet is developed face each other. The second side surface part 115 as an opposed surface of the first side surface part 113 has the same size as the first side surface part 113, is foldably and continuously formed to the other end of the front surface part 111 to form the other side surface of the hexahedron, and includes wing parts adhered to upper and lower portions. The bottom surface part 117 as an opposed surface of the top surface part 112 has the same size as the top surface part 112, is foldably and continuously formed at a lower end of the rear surface part 114 to form a bottom surface of the hexahedron, and includes a lower wing 117a which is folded inward. A flap part 116 is foldably and continuously formed at one end of the second side surface part 115 and folded to be stackable on the rear surface part 114.

In the case of the box formed by the base sheet part 110, as shown in FIG. 3, the contents 500, for example, a pocket type structure for drugs go in and out of the top and bottom surface parts 112 and 117 having a long and narrow shape and therefore the top, bottom, and side surface parts 112, 113, 115 and 117 correspond to a side which the edges of the contents face. Accordingly, it is preferable that the auxiliary space part C₁ is formed to contact any one of the top, bottom, and side surface parts 112, 113, 115 and 117.

In the exemplary embodiment, the auxiliary sheet part 120 does not directly define the auxiliary space part C₁, but surrounds one surface of the contents 500. Therefore, in the inner space defined by the base sheet part 110, a space remained after the auxiliary sheet part 120 surrounds the contents 500 is determined as the auxiliary space part C₁. In this case, it is useful to fully coat the one surface of the contents 500 with metal foil such as silver foil or aluminum foil. As a result, the auxiliary sheet part 120 shields the metal foil of the contents 500 once, thereby physically protecting the RFID tag 1 and remarkably reducing an interference phenomenon of electromagnetic waves due to the metal foil coated on the surface of the contents 500.

According to the present invention, the auxiliary sheet part 120 may include one or more surface parts folded at least once by extending one of the six surface parts of the base sheet part 110 and an adhesion part adhered to the base sheet part 110 at the last free end.

In the shown exemplary embodiment, the auxiliary sheet part 120 includes three folded auxiliary surfaces 121, 122, and 123 which are foldably and continuously formed from one end of the rear surface part 114 of the base sheet part 110, and a last adhesion part 124. The auxiliary sheet part 120 with the four surfaces may define the auxiliary space part C₁ with a quadrangle cross section. According to the present invention, one of the auxiliary surfaces 121, 122, and 123 necessarily serves as a partition separating the auxiliary space part C₁ from the main space part accommodating the contents. The one auxiliary surface serving as the partition is sufficient and it is not necessary for the shape of the cross section of the auxiliary space part C₁ to be a quadrangle. Accordingly, in the exemplary embodiment, the number of the auxiliary surfaces of the auxiliary sheet part 120 is three, but is not limited thereto and at least one auxiliary surface is sufficient.

Continuously referring to the shown exemplary embodiment, the first auxiliary surface 121 of the auxiliary sheet part 120 is foldably and continuously connected from one end of the rear surface part 114 of the base sheet part 110 and faces the first side surface part 113, but has a width narrower than that of the first side surface part 113 by two times the thickness of the sheet and a length shorter than or equal to that of the first side surface part 113. The second auxiliary surface 122 is foldably and continuously formed from one end of the first auxiliary surface 121 and has a length shorter than that of the front surface part 111 by a predetermined distance. The third auxiliary surface 123 is foldably and continuously formed from one end of the second auxiliary surface 122 and faces the first auxiliary surface 121. The adhesion part 124 is foldably and continuously formed from one side of the third auxiliary surface 123 and adhered to an inner surface of the rear surface part 114. As a result, one side of the auxiliary sheet part 120 is connected to the rear surface part 114 of the base sheet part 110 and the other side thereof is fixed to the inner surface of the rear surface part 114 by the adhesion part 124. In the exemplary embodiment, the auxiliary space part C₁ is a long tube type having a quadrangle cross section, in which one surface thereof is formed by the third auxiliary surface of the auxiliary sheet part and the other three surfaces are formed by the three surface parts of the base sheet part. The third auxiliary surface 123 of the auxiliary sheet part 120 serves as a partition separating the auxiliary space part C₁ from the main space part.

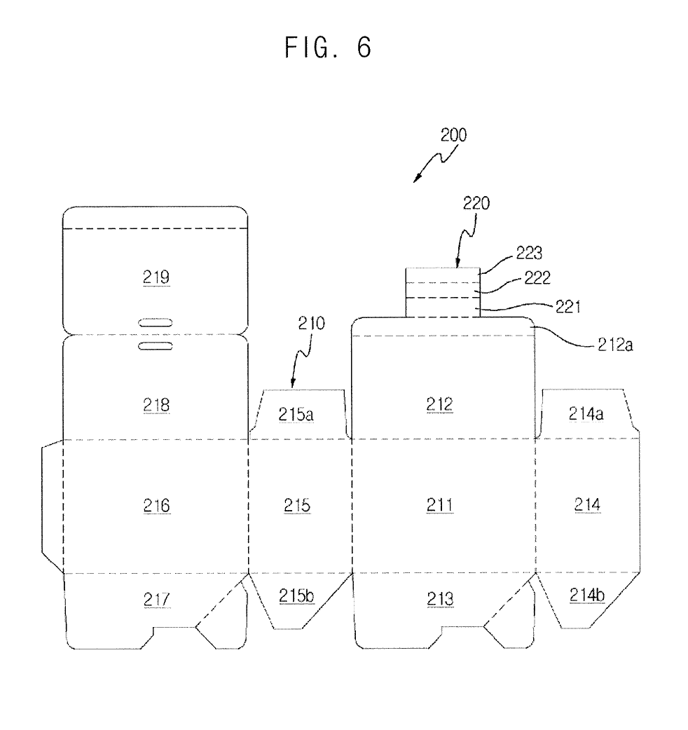

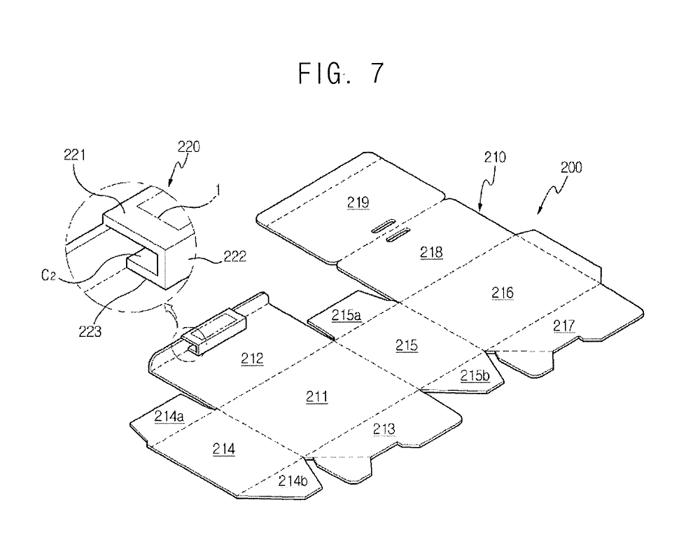

FIGS. 6 to 8 illustrate a packaging box according to a second exemplary embodiment of the present invention.

Similarly as in the first exemplary embodiment, in the second exemplary embodiment, one sheet for a hexahedral packaging box 200 is provided. The sheet includes a base sheet part 210 and an auxiliary sheet part 200, which are continuously formed.

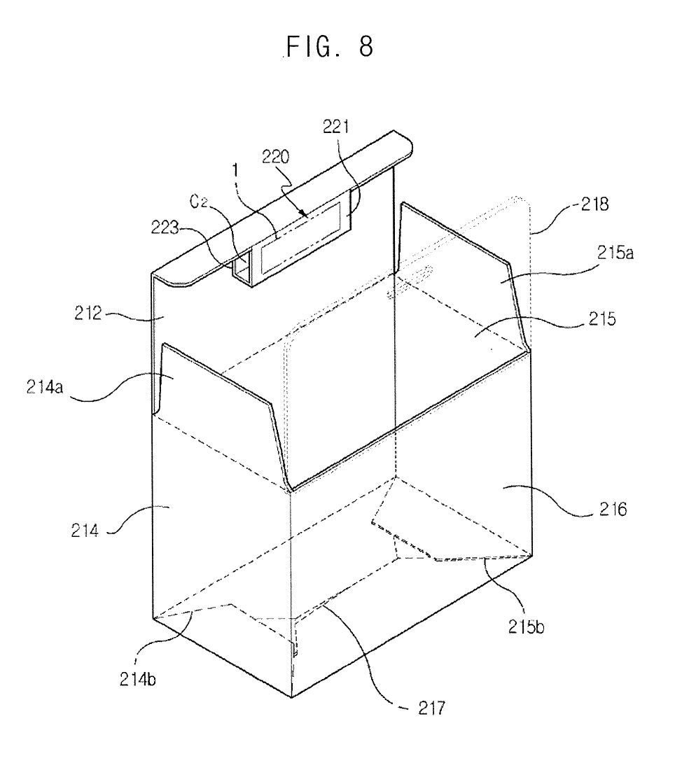

In the second exemplary embodiment, after the base sheet part 210 is folded, as shown in FIG. 8, a hexahedral box is formed in a shape having wide front and rear surfaces similarly as substantially wide top and bottom surfaces and includes an inner space having a corresponding hexahedral shape inside. As shown in the drawings, the sheet for the packaging box 200 includes a front surface part 211, a top surface part 212, a first side surface part 214, a second side surface part 215, and a rear surface part 216 that form top, bottom, side, front, and rear surfaces, and a bottom surface is constituted by a first bottom surface 213, a second bottom surface 217, a lower wing 214b of the first side surface part and a lower wing 215b of the second side surface part which fit together and are stacked.

As shown in FIG. 6, the base sheet part 210 is folded to form a hexahedral shape. The front surface part 211 is a surface part forming a front surface of the hexahedron. The top surface part 212 is foldably and continuously formed at an upper end of the front surface part 211 to form a top surface or a lid of the hexahedron, and has an upper wing 212a which is folded inward. The first bottom surface part 213 is foldably and continuously formed at a lower end of the front surface part 211 to form a portion of the bottom surface of the hexahedron. The first side surface part 214 is foldably and continuously formed at one end of the front surface part 211 to form one side surface of the hexahedron and has an upper wing 214a and a lower wing 214b which are foldably and continuously formed at upper and lower ends. The upper wing 214a of the first side surface part 214 is folded inside the top surface and the lower wing 214b is folded inside the bottom surface. The second side surface part 215 is foldably and continuously formed at the other end of the front surface part 211 to form the other side surface of the hexahedron and has an upper wing 215a and a lower wing 215b which are foldably and continuously formed at upper and lower ends. The upper wing 215a of the second side surface part 215 is folded inside the top surface and the lower wing 215b is folded inside the bottom surface. The rear surface part 216 is foldably and continuously formed at one end of the second side surface part 215 and corresponds to the front surface part 211. The second bottom surface part 217 is foldably and continuously formed at a lower end of the rear surface part 216 to form another portion of the bottom surface of the hexahedron. Flap parts 218 and 219 form one surface by overlapping two surfaces, i.e., a first flap part 218 and a second flap part 219 to increase durability. The first flap part 218 is foldably and continuously formed at an upper end of the rear surface part 216 and folded to be stackable on the surface of the top surface part 212. The second flap part 219 is foldably and continuously formed at an upper end of the first flap part 218 and overlaps with the first flap part 218 and may include an adhesion part adhering ends of the first flap part 218 and the second flap part 219 to each other at a free end of the second flap part 219.

In the case of the box formed by the base sheet part 210, as shown in FIG. 8, all the six surfaces have relatively large areas compared with the RFID tag. Therefore, the RFID tag may be included in any one of the six surfaces, but when the auxiliary space part is formed all over the six surfaces, a very large auxiliary space part may be unnecessarily formed. In this case, it is preferable that the auxiliary space part is formed only at a portion of the corner. As such, the auxiliary space part C₂ formed in the exemplary embodiment is formed at the corner formed by two or more surfaces of the base sheet part 210.

In the exemplary embodiment, the auxiliary sheet part 220 directly defines the auxiliary space part C₂ having a quadrangle-shaped cross section together with a portion of the base sheet part 210. Therefore, in an inner space defined by the base sheet part 210, the auxiliary sheet part 220 determines a shape of the auxiliary space part C₂ together with the folded wing part of the base sheet part 210. In this case, since the auxiliary space part C₂ is positioned at the corner where the RFID tag 1 is least physically interfered by the contents, it is possible to install the RFID tag 1 having a shape that saves the most space.

According to the present invention, the auxiliary sheet part 220 may be extended from one of the six surface parts of the base sheet part 210, but may include one or more surfaces folded at least once by being extended from the folded wing part similarly as in the exemplary embodiment and an adhesion part adhered to the base sheet part 210 at a last free end.

In the shown exemplary embodiment, the auxiliary sheet part 220 includes two folded auxiliary surfaces 221 and 222 foldably and continuously formed from an end of the folded upper wing 212a formed at a free end of the top surface part 212 of the base sheet part 210 and folded inward to be folded, and a last adhesion part 223. In the exemplary embodiment, the number of auxiliary surfaces of the auxiliary sheet part 220 is smaller than that in the first exemplary embodiment because a portion of the base sheet part 210 is used in place of the auxiliary surface.

As shown in the drawings, the auxiliary sheet part 220 is constituted by a first auxiliary surface 221 foldably and continuously formed at an upper end of the upper wing 212a of the top surface part 212 and facing the top surface part 212; a second auxiliary surface 222 foldably and continuously formed from the first auxiliary surface 221 and facing the upper wing 212a; and an adhesion part 223 foldably and continuously formed from the second auxiliary surface 222 and adhered to an inner surface of the top surface part 212 and the auxiliary space part C₂ may be formed inside the upper wing 212a of the top surface part, the first and second auxiliary surfaces 221 and 222 and the adhesion part 223. As a result, one side of the auxiliary sheet part 220 is connected to the top surface part 212 of the base sheet part 210 and the other side thereof is fixed to the inner surface of the top surface part 212 by the adhesion part 223, such that the auxiliary space part C₂ is formed at a portion of the top surface part 212 that is a lid of the box and the second auxiliary surface 222 of the auxiliary sheet part 220 serves as a partition separating the auxiliary space part C₂.

In the case of the packaging box 100 according to the first exemplary embodiment of the present invention, the auxiliary sheet part is extended from one surface part of the base sheet part, while in the case of the packaging box 200 according to the second exemplary embodiment of the present invention, the auxiliary sheet part is extended from the folded wing part instead of the surface part of the base sheet part.

Meanwhile, in packaging boxes 300 and 400 according to third and fourth exemplary embodiments described below, auxiliary sheet parts are characterized by being extended from adhesion parts 316b and 418 adhered to surface parts instead of the surface part of the base sheet part or the folded wing part.

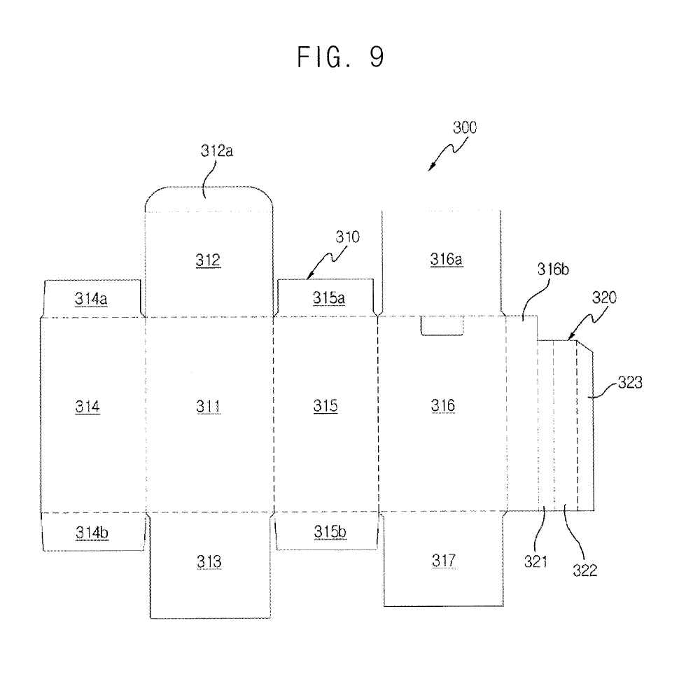

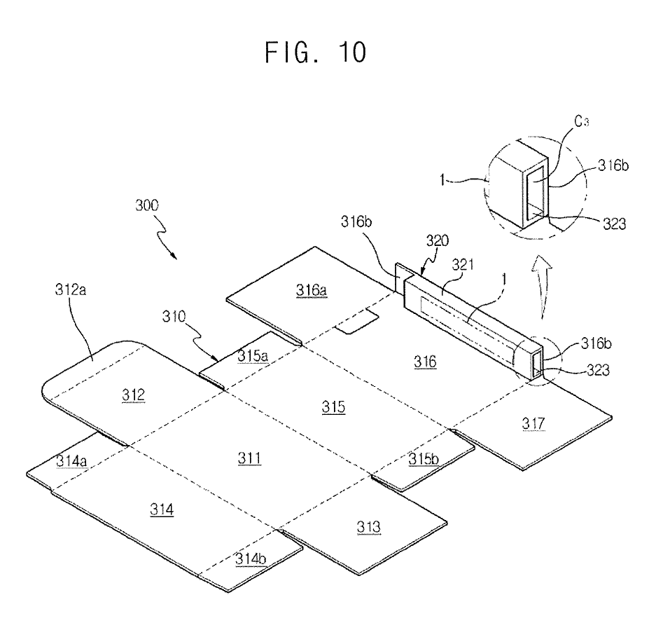

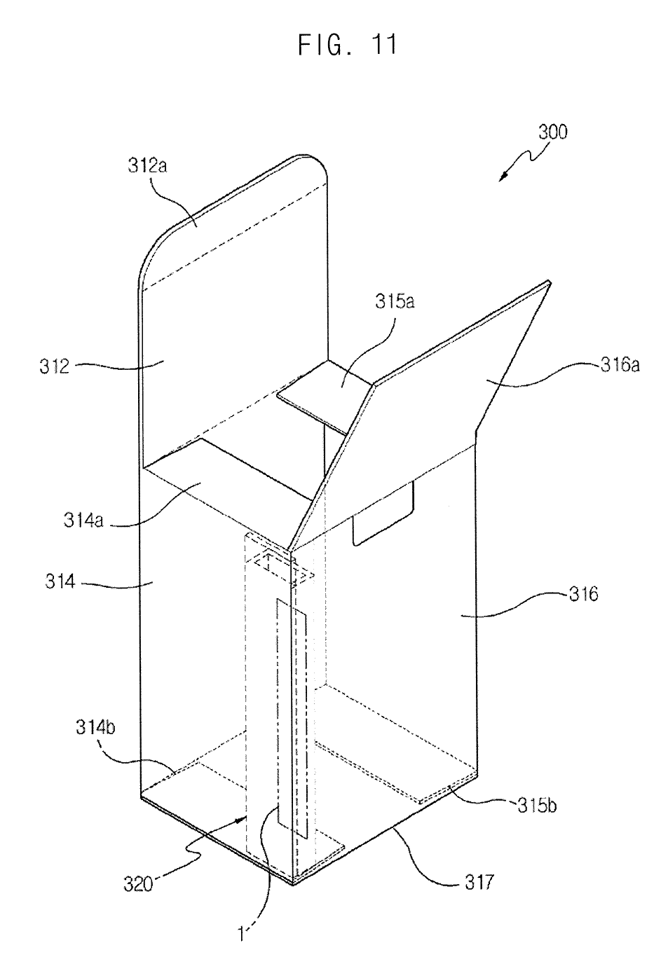

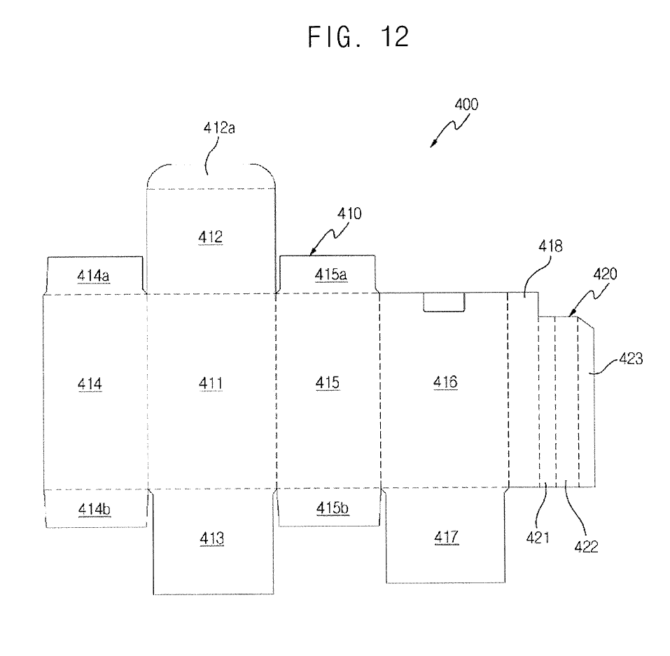

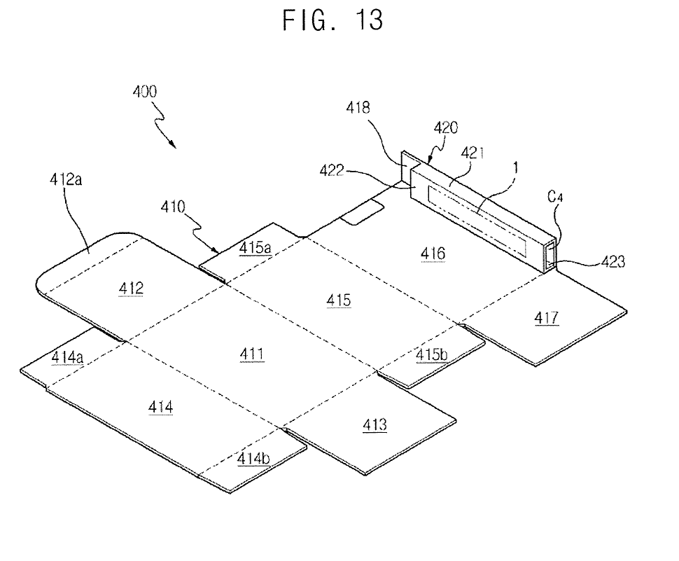

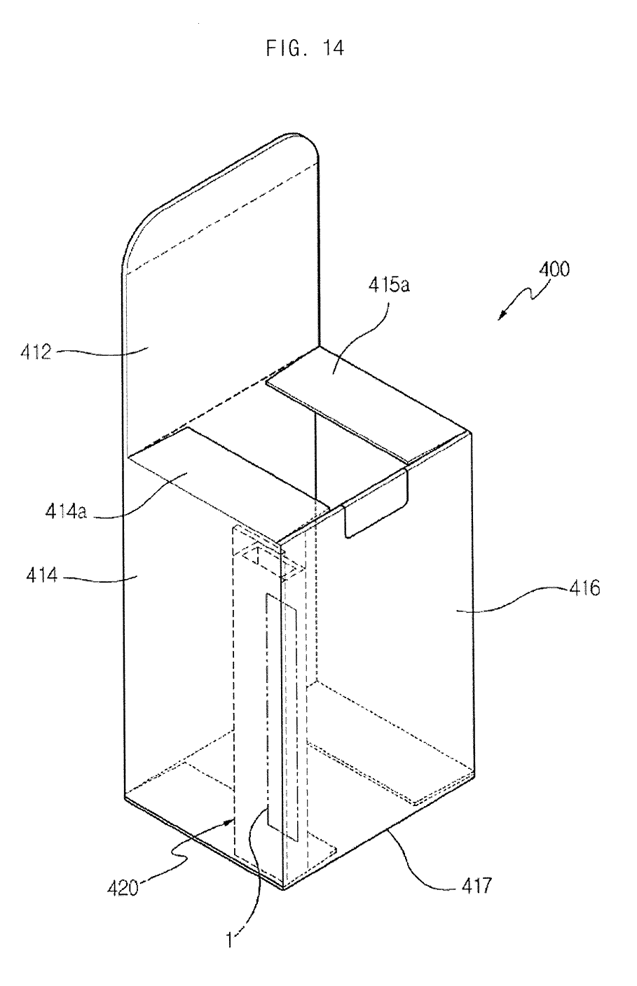

In the third and fourth exemplary embodiments according to the present invention, the packaging boxes 300 and 400 are similar to each other, but the difference is whether a flap part 316s exists or not. The third exemplary embodiment is shown in FIGS. 9 to 11 and the fourth exemplary embodiment is shown in FIGS. 12 to 14.

As shown in the drawings, the base sheet parts 310 and 410 are folded to form the shape of a hexahedron and may include front surface parts 311 and 411 forming front surfaces of the hexahedrons; top surface parts 312 and 412 foldably and continuously formed at upper ends of the front surface parts to form top surfaces of the hexahedrons and having upper wings 312a and 412a; bottom surface parts 313 and 413 foldably and continuously formed at lower ends of the front surface parts 311 and 411 to form bottom surfaces of the hexahedrons; first side surfaces 314 and 414 foldably and continuously formed at one ends of the front surface parts 311 and 411 to form one side surfaces of the hexahedrons and having upper and lower wings 314a and 314b and 414a and 414b at upper and lower ends; second side surface parts 315 and 415 foldably and continuously formed at the other ends of the front surface parts 311 and 411 to form the other side surfaces of the hexahedrons and having upper and lower wings 315a and 315b and 415a and 415b at upper and lower ends; and rear surface parts 316 and 416 foldably and continuously formed at one ends of the second side surface parts 315 and 415 to form rear surfaces of the hexahedrons and having wings 317 and 316b and 417 and 418 at lower sides and one ends, respectively. Unlike the packaging box 400 according to the fourth exemplary embodiment, the packaging box 300 of the third exemplary embodiment may further include a flap part 316a foldably and continuously formed at an upper end of the rear surface part 316 and folded to be stackable on the surface of the top surface part 312.

In this case, the auxiliary sheet parts 320 and 420 each include two foldable auxiliary surfaces and one adhesion part. The two foldable auxiliary surfaces form a tube having a quadrangle cross section together with the lateral wings 316b and 418 of the base sheet part 310 and 410. As shown in the drawings, the auxiliary sheet parts 320 and 420 may include first auxiliary surfaces 321 and 421 foldably and continuously formed at lateral ends of the lateral wings 316b and 418 that are adhesion parts formed on one side surfaces of the rear surface parts 316 and 416 and facing the rear surface parts; second auxiliary surfaces 322 and 422 foldably and continuously formed from the first auxiliary surfaces and facing the lateral wings 316b and 418; and adhesion parts 323 and 423 foldably and continuously formed from the second auxiliary surfaces and adhered to inner surfaces of the rear surface parts, such that auxiliary spaces C₃ and _{C4} are formed having quadrangle cross sections inside the lateral wings 316b and 418, the first and second auxiliary surfaces 321 and 322 and 421 and 422, and the adhesion parts 323 and 423, thereby installing the RFID tag 1.

Although the present invention has been described on the basis of exemplary embodiments, the present invention is not particularly limited to the exemplary embodiments and it should be understood that various modifications and changes can be made without departing from the spirit and scope of the present invention. Accordingly, the appended claims will include these modification or changes as long as they belong to the gist of the present invention.

As described above, the packaging box with the RFID tag having the configuration according to the exemplary embodiments may be widely used in the fields where the RFID is provided in the packaging box of articles such as electronic components made of metal as well as articles such as drugs, foods, cigarettes or cigarette tobaccos, and chocolates.

1. A packaging box with a radio frequency identification (RFID) tag, comprising:
a main space part accommodating contents; and
an auxiliary space part C₁, C₂, C₃, and C₄ separated from the main space part through a partition,
wherein the auxiliary space part is provided with a radio frequency identification (RFID) tag 1 and the surface of at least a portion of the auxiliary space part forms a portion of the surface of the packaging box.

2. The packaging box with a radio frequency identification (RFID) tag of claim 1, wherein the packaging box has the shape of a polyhedron formed by folding one sheet.

3. The packaging box with a radio frequency identification (RFID) tag of claim 2, wherein on the one sheet, a base sheet part 110, 210, 310, and 410 forming an exterior shape of the packaging box and an auxiliary sheet part 120, 220, 320, and 420 forming the auxiliary space part are continuously formed.

4. The packaging box with a radio frequency identification (RFID) tag of claim 1, wherein the surface of at least a portion of the auxiliary space part that is a portion of the surface of the packaging box has a planar shape.

5. The packaging box with a radio frequency identification (RFID) tag of claim 4, wherein the RFID tag 1 is constructed by printing an antenna pattern 1a on one side surface of the auxiliary space part with conductive ink and separately attaching a strap 1b to the center of the antenna pattern so that the antenna pattern and the strap are electrically connected to each other.

6. The packaging box with a radio frequency identification (RFID) tag of claim 3, wherein the base sheet part 110 is folded to form the shape of a hexahedron, the base sheet part including: a front surface part 111 forming a front surface of the hexahedron;
a top surface part 112 foldably and continuously formed at an upper end of the front surface part to form a top surface of the hexahedron and having an upper wing; a first side surface part 113 foldably and continuously formed at one end of the front surface part to form one side surface of the hexahedron; a rear surface part 114 foldably and continuously formed at one end of the first side surface part to form a rear surface of the hexahedron; a second side surface part 115 foldably and continuously formed at the other end of the front surface part to form the other side surface of the hexahedron; a flap part 116 foldably and continuously formed at one end of the second side surface part and folded to be stackable on the rear surface part; and a bottom surface part 117 foldably and continuously formed at a lower end of the rear surface part to form a bottom surface of the hexahedron and having a lower wing.

7. The packaging box with a radio frequency identification (RFID) tag of claim 6, wherein the auxiliary sheet part 120 includes: a first auxiliary surface 121 foldably and continuously formed from one end of the rear surface part 114 of the base sheet part 110 and facing the first side surface part 113; a second auxiliary surface 122 foldably and continuously formed from one end of the first auxiliary surface, having a length shorter than that of the front surface part by a predetermined length, and facing the rear surface part 114; a third auxiliary surface 123 foldably and continuously formed at one end of the second auxiliary surface and facing the first auxiliary surface 121; and an adhesion part 124 foldably and continuously formed from one side of the third auxiliary surface and adhered to an inner surface of the rear surface part 114, such that a space between the third auxiliary surface 123 and the second side surface part 115 forms an auxiliary space part C₁.

8. The packaging box with a radio frequency identification (RFID) tag of claim 3, wherein the base sheet part 210 is folded to form the shape of a hexahedron, the base sheet part including: a front surface part 211 forming a front surface of the hexahedron;
a top surface part 212 foldably and continuously formed at an upper end of the front surface part to form a top surface of the hexahedron and having an upper wing; a first bottom surface part 213 foldably and continuously formed at a lower end of the front surface part to form a portion of a bottom surface of the hexahedron; a first side surface part 214 foldably and continuously formed at one end of the front surface part to form one side surface of the hexahedron and having upper and lower wings foldably and continuously formed at upper and lower ends; a second side surface part 215 foldably and continuously formed at the other end of the front surface part to form the other side surface of the hexahedron and having upper and lower wings foldably and continuously formed at upper and lower ends; a rear surface part 216 foldably and continuously formed at one end of the second side surface part and corresponding to the front surface part; a second bottom surface part 217 foldably and continuously formed at a lower end of the rear surface part to form another portion of the bottom surface of the hexahedron; a first flap part 218 foldably and continuously formed at an upper end of the rear surface part and folded to be stackable on the surface of the top surface part; and a second flap part 219 foldably and continuously formed at an upper end of the first flap part and overlapping with the first flap part.

9. The packaging box with a radio frequency identification (RFID) tag of claim 8, wherein the auxiliary sheet part 220 includes: a first auxiliary surface 221 foldably and continuously formed at an upper end of the upper wing 212a of the top surface part 212 and facing the top surface part; a second auxiliary surface 222 foldably and continuously formed from the first auxiliary surface and facing the upper wing 212; and an adhesion part 223 foldably and continuously formed from the second auxiliary surface and adhered to an inner surface of the top surface part 212, such that an auxiliary space part C₂ is formed inside the upper wing 212a of the top surface part, the first and second auxiliary surfaces 221 and 222, and the adhesion part 223.

10. The packaging box with a radio frequency identification (RFID) tag of claim 3, wherein the base sheet part 310 is folded to form the shape of a hexahedron, the base sheet part including: a front surface part 311 forming a front surface of the hexahedron; a top surface part 312 foldably and continuously formed at an upper end of the front surface part to form a top surface of the hexahedron and having an upper wing; a bottom surface part 313 foldably and continuously formed at a lower end of the front surface part to form a bottom surface of the hexahedron; a first side surface part 314 foldably and continuously formed at one end of the front surface part to form one side surface of the hexahedron and having upper and lower wings at upper and lower ends; a second side surface part 315 foldably and continuously formed at the other end of the front surface part to form the other side surface of the hexahedron and having upper and lower wings at upper and lower ends; a rear surface part 316 foldably and continuously formed at one end of the second side surface part to form a rear surface of the hexahedron and having wings at a lower end and one end, respectively; and a flap part 316a foldably and continuously formed at an upper end of the rear surface part and folded to be stackable on the surface of the top surface part.

11. The packaging box with a radio frequency identification (RFID) tag of claim 10, wherein the auxiliary sheet part 320 includes a first auxiliary surface 321 foldably and continuously formed at a lateral end of a lateral wing 316b formed on one side surface of the rear surface part and facing the rear surface part; a second auxiliary surface 322 foldably and continuously formed from the first auxiliary surface and facing the lateral wing 316b; and an adhesion part 323 foldably and continuously formed from the second auxiliary surface and adhered to an inner surface of the rear surface part, such that an auxiliary space part C₃ is formed inside the lateral wing 316b, the first and second auxiliary surfaces 321 and 322, and the adhesion part 323.

12. The packaging box with a radio frequency identification (RFID) tag of claim 3, wherein the base sheet part 410 is folded to form the shape of a hexahedron, the base sheet part including: a front surface part 411 forming a front surface of the hexahedron;
a top surface part 412 foldably and continuously formed at an upper end of the front surface part to form a top surface of the hexahedron and having an upper wing; a bottom surface part 413 foldably and continuously formed at a lower end of the front surface part to form a bottom surface of the hexahedron; a first side surface part 414 foldably and continuously formed at one end of the front surface part to form one side surface of the hexahedron and having upper and lower wings at upper and lower ends; a second side surface part 415 foldably and continuously formed at the other end of the front surface part to form the other side surface of the hexahedron and having upper and lower wings at upper and lower ends; and a rear surface part 416 foldably and continuously formed at one end of the second side surface part to form a rear surface of the hexahedron and having wings at a lower end and one end, respectively.

13. The packaging box with a radio frequency identification (RFID) tag of claim 12, wherein the auxiliary sheet part 420 includes a first auxiliary surface 421 foldably and continuously formed at a lateral end of a lateral wing 418 formed on one side surface of the rear surface part and facing the rear surface part; a second auxiliary surface 422 foldably and continuously formed from the first auxiliary surface and facing the wing; and an adhesion part 423 foldably and continuously formed from the second auxiliary surface and adhered to an inner surface of the rear surface part, such that an auxiliary space part C₄ is formed inside the lateral wing 418, the first and second auxiliary surfaces 421 and 422, and the adhesion part 423.
